(19) United States
(12) Patent Application Publication
(10) Pub. No.: US 2006/0258230 A1
(43) Pub. Date: Nov. 16, 2006

(54) Electrical connector

(75) Inventor: Wei Hua Pan, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD

(21) Appl. No.: 11/432,214

(22) Filed: May 10, 2006

(30) Foreign Application Priority Data
May 10, 2005 (CN) 200520071598.X

(51) Int. Cl. H01R 11/03

(52) U.S. Cl. 439/790

(57) ABSTRACT

An electrical connector includes an insulating housing, a plurality of contacts and a spacer. The insulating housing has several rows of passageways for receiving the contacts and a pair of grooves on the sidewalls. The spacer includes a base portion and a rear wall, both ends of the base portion has a pair of mounting arms correspondingly fit in the grooves. The rear wall encloses the contacts into the space between the insulating housing and the spacer in order to prevent the contacts from being damaged. Thus, when the connector needs different height, only changing the height of the spacer will be enough to change the height of the whole electrical connector which reduces the difficulty of the mold development of the insulating housing and the cost also.

### BACKGROUND OF THE INVENTION

1. Field of the Invention

The present invention relates to an electrical connector, and more particularly to an electrical connector mounted on a circuit board.

2. Description of Related Art

U.S. Pat. No. 5,906,518 discloses an electrical connector. As shown in FIG. 1, the electrical connector 10 comprises an insulating housing 20, several rows of contacts 30 received in the insulating housing 20, a pin aligment plate 40 for holding the contacts 30 and a pair of board retention members 50. A pair of mounting flanges 28a, 28b are formed at the opposite ends of the insulating housing 20. A pair of openings 29a, 29b are defined in and extending through the mounting flanges 28a, 29b for receiving the board retention members 50. The board retention members 50 are secured in mounting flanges 28a, 29b. The connector 10 can meet the demands of different height only by changing the height of the mounting flanges 28a, 28b. So it is necessary to manufacture different insulating housings 20 with different height, which lead to manufacture different accessories correspondingly and increase the cost.

U.S. Pat. No. 6,022,227 discloses an electrical connector. As shown in FIG. 5, the electrical connector comprises a dielectric housing 30, a plurality of terminals 32 and a spacer 38. A pair of mouting arms 46 are formed at both ends of the dielectric housing 30. The spacer 38 has two support sections 48 upwardly extending from the opposite ends thereof. The support sections 48 connect the dielectric housing 30 with the spacer 38 by riveting the nuts 68 and bolts 70. By changing the height of the support sections 48, the whole electrical connector can change its height. However, in assembly, the electrical connector needs additional nuts 68 and bolts 70 in order to link the dielectric housing 30 and the spacer 38, which brings a complicated assembly and high cost. Moreover, the terminals 32 are exposed in the space between the two support sections 48 which makes the terminals 32 be damaged easily.

### SUMMARY OF THE INVENTION

The object of the present invention is to provide an electrical connector which can meet the demands of different height and prevent the contacts from being damaged efficiently.

In order to achieve above-mentioned object, an electrical connector is provided and it comprises an insulating housing having a plurality of passageways and a pair of grooves, a plurality of contacts received in the insulating housing, a spacer. The spacer has a base portion, a rear wall extending from the base portion and a pair of mounting arms formed on the base portion, the mounting arms of the spacer are mating with the grooves of the insulating housing, and the connected portions of the contacts are enclosed by the insulating housing and the spacer.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled, perspective view of the electrical connector in accordance with the present invention;

FIG. 2 is an exploded view of the electrical connector shown in FIG. 1;

FIG. 3 is an exploded view of the electrical connector similar to FIG. 2, but taken from another aspect; and

FIG. 4 is a cross-section view of the electrical connector taken along line 4-4 of FIG. 1.

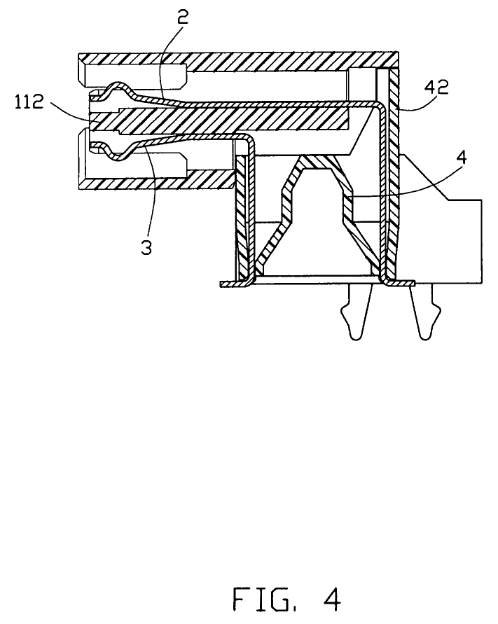

### DETAILED DESCRIPTION OF THE INVENTION

Reference will now be made to the drawing figures to describe the preferred embodiment of the present invention in detail.

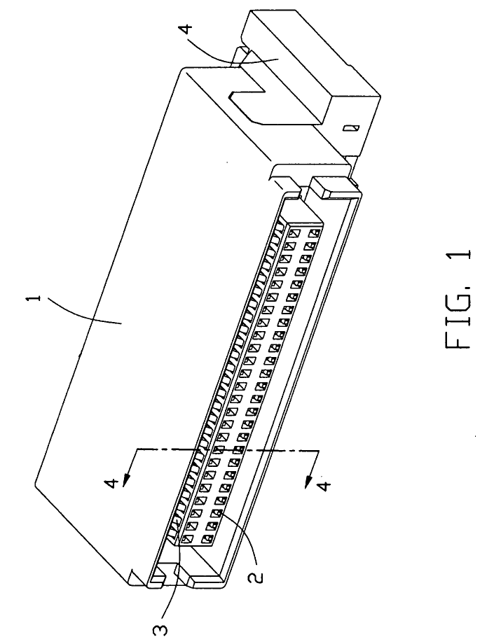

Referring to FIGS. 1 to 3, an electrical connector in accordance with the present invention is provided. The electrical connector comprises an insulating housing 1, a plurality of contacts comprising a first row contacts 2 and a second row contacts 3 received in the insulating housing 1, a spacer 4 and a pair of board retention members 5.

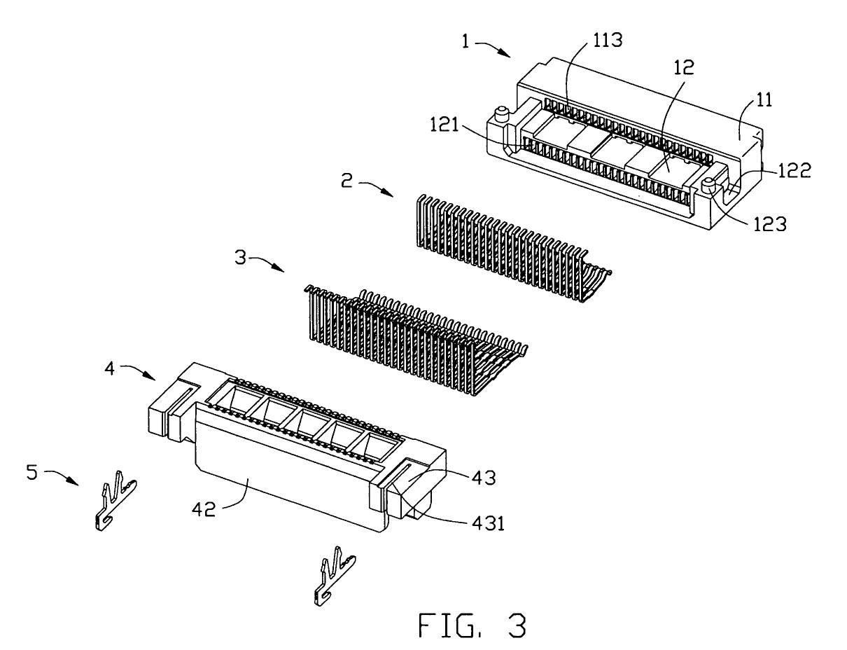

The insulating housing 1 includes a top wall, a bottom wall and several sidewalls. The insulating housing 1 has a mating portion 11 for mating with a mating connector and a mounting portion 12 rearwards extending from the mating portion 11. The mating portion 11 and mounting portion 12 define a trapezium structure. A mating opening 111 is defined in a front end of the mating portion 11 and the housing contains a tongue portion 112 exposed in the mating opening 111 as the view of FIG. 3. The tongue portion 112 has two rows of passageways 113, 121 respectively on an upper and a lower surfaces, which pass through the mating portion 11 and mounting portion 12 rearwards. The mounting portion 12 has a pair of L-shaped grooves 122 formed on the sidewalls and two guiding posts 123 extending downwards from the bottom wall.

The two rows of contacts 2, 3 are made of metal. Each of the contacts 2, 3 both comprises a contacting arm 21, 31 mating with contacts of the mating connector, a holding portion 22, 32 extending rearwards from the contacting arm 21, 31, a connected portion 23, 33 which extends rearwards from the holding portion 22, 32 and be bent at a right angle, and a solder tail 24, 34 which is bent at a substantially right angle at the end of the connected portion 23, 33. The solder tail 24, 34 is soldered on the circuit board by SMT. The contacting arms 21, 31 are received and fixed in the passageways 113, 121 on the tongue portion 112 of the insulating housing 1.

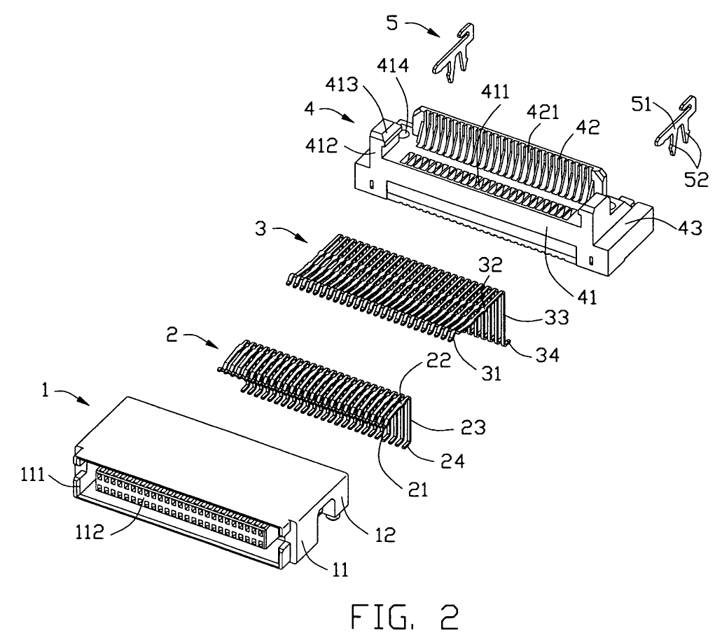

Referring to FIG. 2, the spacer 4 includes a longitudinal base portion 41, a rear wall 42 in a vertical direction with the base portion 41 and a pair of mounting flanges 43 formed at opposite ends of the base portion 41 lengthwise. A plurality of the first receiving holes 411, which pass through the upper surface and the lower surface of the base portion 41, are formed in front of the base portion 41 for receiving the first row of contacts 2. A plurality of the second receiving holes 421, which also pass through the base portion 41 downwards, are formed on one side surface of the rear wall 42. A pair of mounting arms 412 are extending upwardly at opposite ends of the base portion 41. Each of the mounting arms 412 has a protrusion 413 on the top edge. The base portion 41 has two guiding holes 414 each of which is formed next to each mounting arm 412. The mounting arms 412 and guiding holes 414 are respectively coupled with the L-shaped grooves 122 on the mounting portion 12 of the insulating housing and the guiding posts 123. As shown in FIG. 3, an open slot 431 is disposed in the rear part of each mounting flange 43.

Each of the board retention members 5 comprises a vertical portion 51 and two legs 52 extending downwards from the vertical portion 51. The vertical portion 51 is fit in the open slot 431 while the legs 52 are received in the holes on the circuit board in order to achieve a firm connection with the circuit board.

When assembling the connector, first, the two rows of contacts 2, 3 are inserted into the passageways 113, 121 as semi-manufactured goods, and then bend the parts of the contacts 2, 3 extending out of the passageways 113, 121 at a right angle in order to form the connected portion 23, 33, and then fit the spacer 4 into the insulating housing 1 by coupling the guiding posts 123 with the guiding holes 414. And the connected portion 23, 33 of the contacts 2, 3 are respectively received in the first and second receiving holes 411, 421 formed on the base portion 41 and the rear wall 42 of the spacer 4. The rear wall 42 of the spacer 4 mates with the lower surface of the insulating housing 1 in order to make the connected portions 23, 33 of the contacts 2, 3 be enclosed entirely by the insulating housing 1 and the spacer 4. The protrusions 413 on the top edge of the mounting arms 412 are fit in the L-shaped grooves 122 at opposite ends of the mounting portion 12 of the insulating housing 1. At last, bend the parts of the connected portion 23, 33 extending out of the bottom of the base portion 41 at a right angle. And the rest parts of the contacts 2, 3 after being cut down the excrescent, formed the solder tails 24, 34.

As the height of the whole electrical connector mentioned in the embodiment depends on the height of the insulating housing 1 and the spacer 4, only changing the height of the mounting arms 412 and the rear wall 42 will achieve to change the height of the whole electrical connector so that it can adjust the height of the electrical connector for the demands of different height. That is, the insulating housing 1 can be molded independently. First, the contacts 2, 3 are assembled into the insulating housing 1 as semi-manufactured goods, and then the spacers 4 with different height are assembled into the insulating housing 1 so that it can assemble different electrical connectors with different height without changing the structure of the insulating housing 1. As the manufacture process of the insulating housing 1 is complicated and needs a higher demand for precision and rigidity, it will be enough to develop only one set of mold of the insulating housing 1 while the spacer 4 needs several sets of mold for its relative lower demand for precision and rigidity. As a result, it lowers the difficulty of the manufacture and the cost of the process. In addition, the spacer 4 further includes a rear wall 42 which encloses the bareness connected portion 23, 33 of the contacts 2, 3 into the space between the insulating housing 1 and the spacer 4 in order to efficiently prevent the contacts from being damaged.

However, it is to be understood that the present invention is not limited to the shown embodiment and various modifications can be made without departing from the subject matter of the present invention. For example, the guiding posts 123 may be formed on the spacer 4 next to the mounting arms 412 while the corresponding guiding holes 414 may be formed on the mounting portion 12 of the insulating housing 1 next to the L-shaped grooves 122. Also, the rear wall 42 of the base portion 41 is a smoothness wall without any passageways on the surface which encloses the connected portion 23, 33 of the contacts 2, 3 into the space between the insulating housing 1 and the spacer 4.

What is claimed is:

1. An electrical connector comprising:
an insulating housing having a plurality of passageways and a pair of grooves;
a plurality of contacts received in the insulating housing, each contact having a contacting portion, a connected portion and a solder tail;
a spacer having a base portion, a rear wall extending from the base portion and a pair of mounting arms formed on the base portion; and
the mounting arms of the spacer mating with the corresponding grooves of the insulating housing, and the connected portions of the contacts are enclosed by the insulating housing and the spacer.

2. The electrical connector as claimed in claim 1, wherein the insulating housing includes a mating portion and a mounting portion, the grooves are formed on the sidewalls of the mounting portion and the mounting arms extend upwardly from the opposite ends of the base portion of the spacer.

3. The electrical connector as claimed in claim 2, wherein each of the mounting arms has at least one protrusion on its top edge, and each of the grooves is L-shaped, and each of the mounting arms is engaged with the insulating housing by fastening the protrusions into the grooves.

4. The electrical connector as claimed in claim 1, wherein the insulating housing has a guiding post to mate with a guiding hole of the spacer.

5. The electrical connector as claimed in claim 1, wherein both the base portion and rear wall of the spacer have several rows of receiving holes respectively extending downwards and passing through the base portion for receiving the contacts.

6. The electrical connector as claimed in claim 5, the insulating housing includes a tongue portion which contains a plurality of passageways extending rearwards for receiving the contacts.

7. The electrical connector as claimed in claim 6, each of the contacts includes a contacting arm, a holding portion, a connected portion and a solder tail.

8. The electrical connector as claimed in claim 7, wherein the contacting arm and holding portion are correspondingly received in the passageway, and the connected portion is received in the receiving hole which is formed on the base portion and the rear wall of the spacer.

9. The electrical connector as claimed in claim 1, wherein a pair of mounting flanges are formed at opposite ends of the base portion of the spacer, and an open slot is disposed in the rear part of each mounting flange.

10. The electrical connector as claimed in claim 9, wherein the electrical connector further includes a pair of board retention members which are fit in the open slots, each of the board retention members has a vertical portion and at least one leg extending downwards from the vertical portion.

11. The electrical connector as claimed in claim 1, wherein the plurality of contacts received in the insulating housing are divided into two rows.

12. The electrical connector as claimed in claim 1, wherein the spacer is located under the insulating housing.

13. An electrical connector comprising:
an insulating housing having a plurality of horizontal passageways;
a plurality of contacts forwardly assembled to the insulating housing from a rear face of the housing, each contact having a contacting portion received in the corresponding passageways, respectively, and a horizontal solder tail and a vertical connected portion intermediating between said contacting portion and said solder tail; and
a spacer upwardly assembled to the housing and having a base portion defining a plurality of vertical receiving holes receiving the corresponding connected portions therein; wherein
the horizontal solder tails are not of a final shape but of a straight manner, before the spacer is assembled to the housing.

14. The connector as claimed in claim 13, wherein there are two rows of said contacts, and the solder tails of said two rows of the contacts extend in opposite directions horizontally.
